(19) United States
(12) Patent Application Publication
(10) Pub. No.: US 2012/0074135 A1
(43) Pub. Date: Mar. 29, 2012

(54) Electric Induction Heat Treatment of Continuous Longitudinally-Oriented Workpieces

(76) Inventor: John Justin MORTIMER, Genesee, WI (US)

(21) Appl. No.: 13/243,033

(22) Filed: Sep. 23, 2011

Related U.S. Application Data
(60) Provisional application No. 61/386,213, filed on Sep. 24, 2010.
(60) Provisional application No. 61/385,835, filed on Sep. 23, 2010.

(51) Int. Cl. H05B 6/10; H05B 6/02; H05B 6/36

(52) U.S. Cl. 219/672; 219/600

(57) ABSTRACT

Multiple longitudinally-oriented continuous workpieces move through separate longitudinally-oriented through-gaps in an open-box rectangular ferromagnetic material that has multiple longitudinally-oriented through-gaps. A transverse magnetic flux established in each through-gap inductively heats the workpiece moving through each through-gap. Alternatively a single longitudinally-oriented workpiece moving through a single adjustable-width longitudinally-oriented through-gap in an open-box rectangular ferromagnetic material is inductively heated by a transverse flux established in the adjustable-width longitudinally-oriented through-gap.

### CROSS-REFERENCE TO RELATED APPLICATIONS

This application claims the benefit of U.S. Provisional Application No. 61/385,835, filed Sep. 23, 2010, and U.S. Provisional Application No. 61/386,213, filed Sep. 24, 2010, each of which is hereby incorporated by reference in its entirety.

### FIELD OF THE INVENTION

The present invention relates to electric induction heat treatment of longitudinally-oriented continuous workpieces such as rods, wire, and cables formed from a plurality of wires, where the workpiece travels through a longitudinally-oriented gap in a magnetic circuit and is exposed to a transverse magnetic field on the gap to inductively heat the section of the longitudinally-oriented continuous workpiece moving through the gap.

### BACKGROUND OF THE INVENTION

U.S. Pat. No. 5,412,183-A (the '183 patent) discloses in FIG. 1 a C-shaped inductor (3) composed of a laminated magnetic yoke (4) with pole windings (5, 6) opposite each other and between a fixed air gap that is used to inductively heat a single axial long workpiece by moving the workpiece through the air gap with a transverse magnetic flux established in the gap. The '183 patent states the disclosed C-shaped inductor is unsatisfactory for heating long products and discloses a number of alternative arrangements that combine the single C-shaped inductor with other inductors to inductively heat a single axial long product.

U.S. Pat. No. 7,459,053 B2 discloses a flux guide induction heating device that is used to inductively heat elongated and non-uniform workpieces in the gap of a magnetic circuit where the workpiece is positioned within the magnetic circuit material, or is positioned in a space between two separate and spaced apart magnetic cores.

It is one object of the present invention to provide an apparatus and method for induction heat treatment of a longitudinally-oriented continuous workpiece, such as a rod, wire, or cable moving through a longitudinally-oriented through-gap of an apparatus comprising a magnetic circuit with a transverse magnetic flux coupling with the workpiece in the through-gap particularly where the apparatus has an adjustable width gap.

It is another object of the present invention to provide an apparatus and method for simultaneous induction heat treatment of multiple longitudinally-oriented workpieces of various configurations and sizes in a plurality of longitudinally-oriented through-gaps of a single apparatus comprising a magnetic circuit by transverse magnetic flux coupling with the multiple workpieces individually positioned in each one of the plurality of longitudinally-oriented through-gaps of the single apparatus.

### SUMMARY OF THE INVENTION

In one aspect the present invention is an electric induction heat treatment apparatus for heat treatment of a plurality of longitudinally-oriented continuous workpieces. A series magnetic loop circuit is formed from an open-box rectangular ferromagnetic material having a plurality of longitudinally-oriented workpiece through-gaps for insertion of one of the workpieces in one of the through-gaps as each of the workpieces moves through one of the through-gaps. Each of the through-gaps has a gap width that establishes a transverse magnetic flux within the gap that is perpendicularly oriented to the workpiece moving through the gap. An inductor is positioned around the open-box rectangular ferromagnetic material adjacent to each side of each one of the through-gaps, and an alternating current power supply is connected to all of the plurality of inductors.

In another aspect the present invention is a method of inductively heat treating a plurality of longitudinally-oriented continuous workpieces. Alternating current power is supplied to a series magnetic loop circuit formed from an open-box rectangular ferromagnetic material having a plurality of longitudinally-oriented workpiece through-gaps. A transverse magnetic flux is established across the width of each one of the workpiece through-gaps, and each one of the workpieces is moved perpendicularly to the transverse magnetic flux through one of the workpiece through-gaps.

In another aspect the present invention is an electric induction heat treatment apparatus for heat treatment of a longitudinally-oriented continuous workpiece. A series magnetic loop circuit is formed from an open-box rectangular ferromagnetic material having an adjustable-width longitudinally-oriented workpiece through-gap for insertion of the workpiece as the workpiece moves through the adjustable-width through-gap. The adjustable-width through-gap has a gap width that establishes a transverse magnetic flux within the adjustable-width through-gap that is perpendicularly oriented to the length of the workpiece moving through the adjustable-width through-gap. An inductor is positioned around the open-box rectangular ferromagnetic material adjacent to each opposing side of the adjustable-width through-gap, and an alternating current power supply is connected to the inductors.

In another aspect the present invention is a method of inductively heat treating a longitudinally-oriented continuous workpiece. Alternating current power is supplied to a series magnetic loop circuit formed from an open-box rectangular ferromagnetic material having an adjustable-width longitudinally-oriented workpiece through-gap. A transverse magnetic flux is established across the width of the adjustable-width through-gap, and the workpiece is moved perpendicularly to the transverse magnetic flux through the adjustable-width through-gap.

The above, and other aspects of the invention, are further set forth in this specification and the appended claims.

### BRIEF DESCRIPTION OF THE DRAWINGS

For the purpose of illustrating the invention, there is shown in the drawings a form which is presently preferred. It being understood, however, that this invention is not limited to the precise arrangements and instrumentalities shown in the drawings.

FIG. 1 is an isometric view of one example of an electric induction heat treatment apparatus of the present invention.

FIG. 2(a) is an isometric view of another example of an electric induction heat treatment apparatus of the present invention utilizing multi-turn solenoidal coils.

FIG. 2(b) is a cross sectional view of the apparatus in FIG. 2(a) through line A-A.

FIG. 2(c) is a cross sectional view of the apparatus in FIG. 2(a) through line B-B.

FIG. 2(d) is a diagrammatic partial isometric view of the apparatus in FIG. 2(a) illustrating one example of connecting the multi-turn solenoidal coils to an alternating source power supply.

FIG. 3(a) is an isometric view of another example of an electric induction heat treatment apparatus of the present invention utilizing single-turn sheet inductors.

FIG. 3(b) is a diagrammatic isometric view of the apparatus in FIG. 3(a) illustrating one example of connecting the single-turn sheet inductors to an alternating current power supply.

FIG. 4(a) is a cross sectional view of another example of an electric induction heat treatment apparatus of the present invention utilizing multi-layer wound ribbon inductors.

FIG. 4(b) is a detail cross sectional view of one of the multi-layer wound ribbon inductors used in the apparatus shown in FIG. 4(a).

FIG. 4(c) is a plan view of one example of a ribbon inductor used in the apparatus shown in FIG. 4(a) before winding around the ferromagnetic material adjacent to a through-gap.

FIG. 4(d) is a cross sectional view of the ribbon inductor shown in FIG. 4(c) and used in the apparatus shown in FIG. 4(a) after winding around the ferromagnetic material adjacent to a through-gap.

FIG. 5 is an isometric view of one example of an electric induction heat treatment apparatus of the present invention with diagrammatic illustration of a longitudinally-oriented continuous workpiece feeder and positioning apparatus.

FIG. 6(a) is a partial detail view of the electric induction heat treatment apparatus shown in FIG. 5 illustrating longitudinally-oriented gap G1.

FIG. 6(b) is a cross sectional view of a diagrammatic gap X-Y Plane for the gap shown in FIG. 6(a).

FIG. 6(c) is a cross sectional view of a longitudinally-oriented continuous workpiece positioned above the gap X-Y Plane.

FIG. 6(d) is a cross sectional detail view of a longitudinally-oriented continuous workpiece centrally located in the gap X-Y Plane.

FIG. 6(e) is a cross sectional view of a longitudinally-oriented continuous workpiece positioned above the central location in the gap X-Y Plane.

FIG. 7 is an isometric view of one example of an electric induction heat treatment apparatus of the present invention wherein individual longitudinally-oriented continuous workpiece strands are induction heat treated in separate longitudinally-oriented gaps and then wound together to form a composite stranded and longitudinally-oriented continuous workpiece.

FIG. 8 is a cross sectional view of one example of an electric induction heat treatment apparatus of the present invention illustrating examples of insertable gap ferrites to accommodate various configurations and sizes of longitudinally-oriented continuous workpieces, or the absence of a workpiece within a longitudinally-oriented through-gap of the apparatus.

FIG. 9(a) is a cross sectional view of another example of an electric induction heat treatment apparatus of the present invention for heat treatment of a single longitudinally-oriented continuous workpiece with an adjustable-width through gap.

FIG. 9(b) through FIG. 9(e) are various field shaping channel tips that can be used in various examples of an electric induction heat treatment apparatus of the present invention.

FIG. 10(a) is a plan view of another example of an electric induction heat treatment apparatus of the present invention for heat treatment of a single longitudinally-oriented continuous workpiece that utilizes a single-turn sheet inductor around the entire length of the ferromagnetic material.

FIG. 10(b) is a cross sectional view of the apparatus shown in FIG. 10(a) through line C-C that illustrates the single-turn sheet inductor enclosing the ferromagnetic material.

FIG. 11(a) is a partial isometric view of another example of an electric induction heat treatment apparatus of the present invention utilizing a sealed chamber within the longitudinally-orientated gap in the apparatus.

FIG. 11(b) is a cross sectional view of the apparatus shown in FIG. 11(a) through line D-D.

### DETAILED DESCRIPTION OF THE INVENTION

While the present invention will be described in connection with a preferred embodiment, it will be understood that it is not intended to limit the invention to that embodiment. On the contrary, it is intended to cover all alternatives, modifications and equivalents as may be included within the scope of the invention.

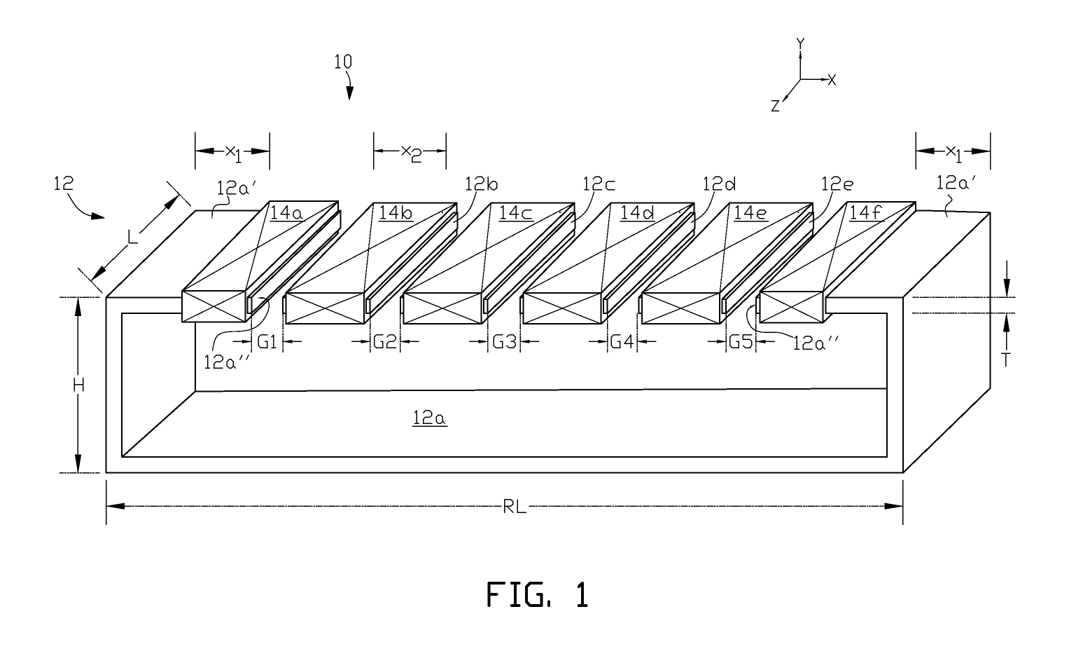

FIG. 1 illustrates one example of an electric induction heat treatment apparatus 10 of the present invention. A magnetic circuit, or flux guide, is formed from a suitable ferromagnetic material 12 arranged in a generally open-box, rectangular configuration with one or more longitudinally air gaps G1 through G5. The ferromagnetic can be, for example, of laminated or pressed powder ferrite form with suitable supporting structure. A longitudinally-oriented continuous workpiece (such as a wire) can be moved through one of the longitudinally-oriented through-gaps so that a transverse magnetic field (oriented in the X-direction of the X-Y-Z orthogonal space illustrated in the figure) established perpendicularly to the length (oriented in the Z-direction) of the workpiece in the gap inductively couples and heats the section of the workpiece moving through the gap. The thickness, T, of the apparatus is determined by the configuration and size of the workpiece, and the length, L, of the gaps is determined by parameters such as the speed of the workpieces moving through the gaps and the level of inductive heating required for the time that a section of the workpiece is within the gap. The height, H, and return length, RL, of the apparatus are minimized as applicable for a particular application. If required for a particular application, ends of C-shaped sections 12a′ are of sufficient length, x₁, to ensure that the magnetic flux in each end section 12a′ is oriented in parallel with the X-axis at the tip 12a″ of each end section so that the flux across gap G1 and gap G5 is substantially parallel across each gap and perpendicular to the length of a workpiece moving through each of these gaps. Minimum spacing x₂, between adjacent gaps is determined by the length, x₂, of the inductors (also referred to as induction coils) required to provide sufficient magnetic flux across a gap to achieve a heating temperature rise for a section of the workpiece passing through the gap in a particular application. In FIG. 1, the inductors, 14a through 14f, are shown diagrammatically and are suitably connected to one or more alternating current power sources (not shown in the figure). In all examples of the invention, suitable mounting structure for the ferromagnetic sections and the induction coils can be provided and is not shown in the drawings. While all of the through-gaps in apparatus 10 are shown along one (upper) side of the apparatus, multiple gaps may be distributed over two or more sides of the apparatus, for example, along the height, H, and/or return length RL.

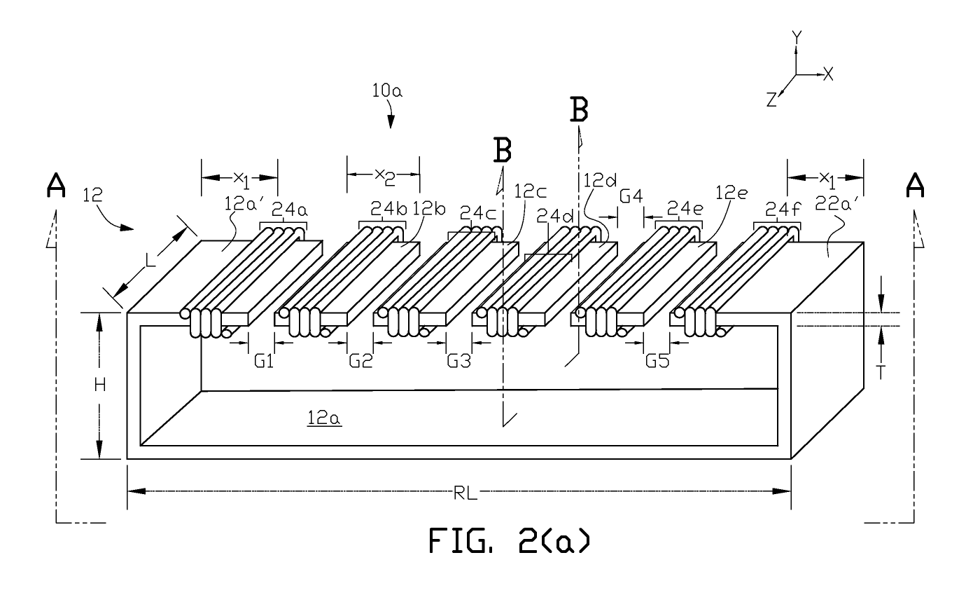

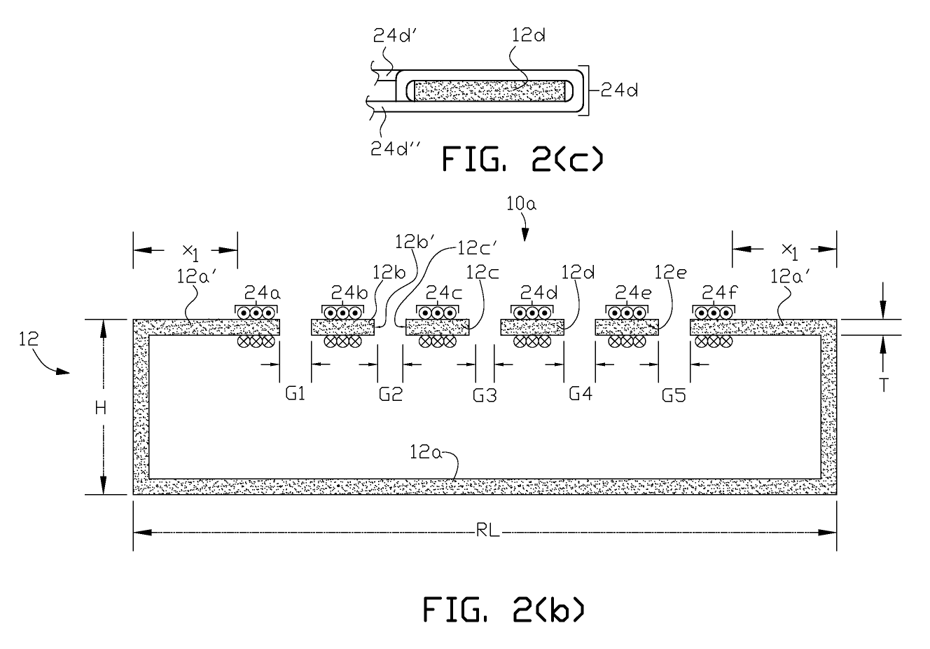

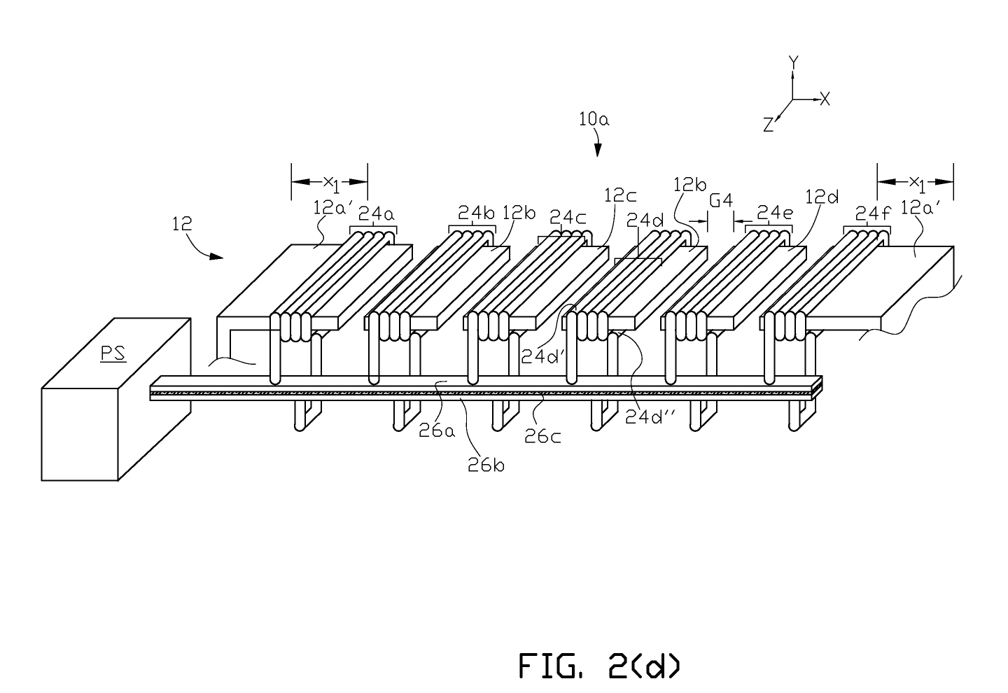

FIG. 2(a), FIG. 2(b) and FIG. 2(c) illustrate apparatus 10a of the present invention, which is similar to the apparatus shown in FIG. 1 except that the inductors are formed from multi-turn solenoidal coils 24a through 24f. Each solenoidal coil is helically wound around each section of ferromagnetic material facing a gap. Although not so illustrated in the drawings, preferably, each coil extends to near the edge of the ferromagnetic material at each gap (for example, edges 12b′ and 12c′ in FIG. 2(b)) so that each coil is positioned around the ferromagnetic material adjacent to a side of the through-gaps. As illustrated in FIG. 2(d), in this example of the invention, each solenoidal coil is suitably connected to power supply bus bars 26a and 26b (separated by dielectric 26c) that supply alternating current to the solenoidal coils (connected in parallel in this example) from single phase power source (PS).

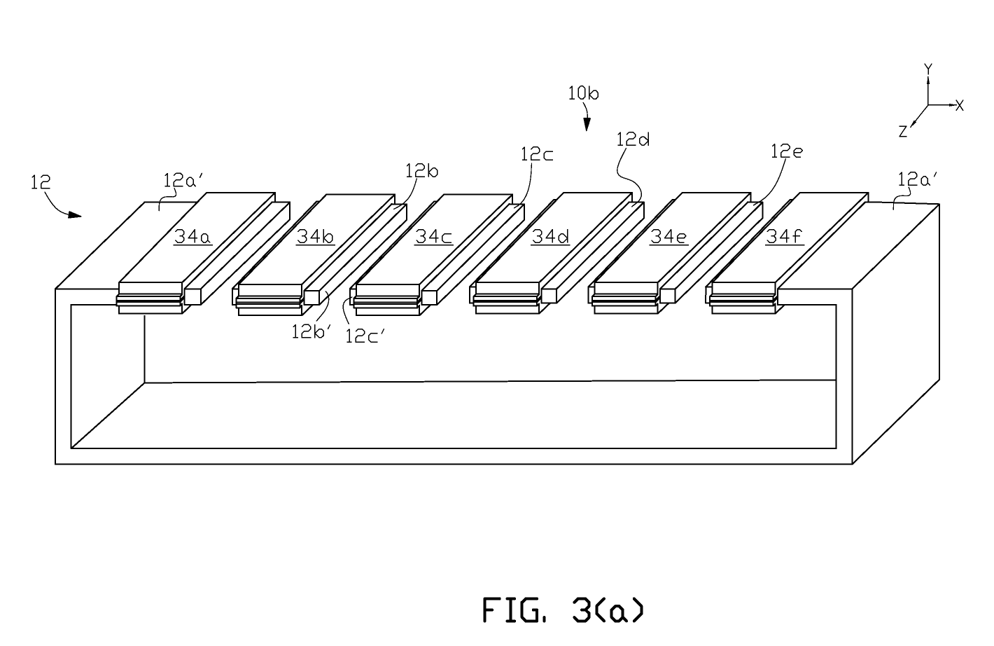

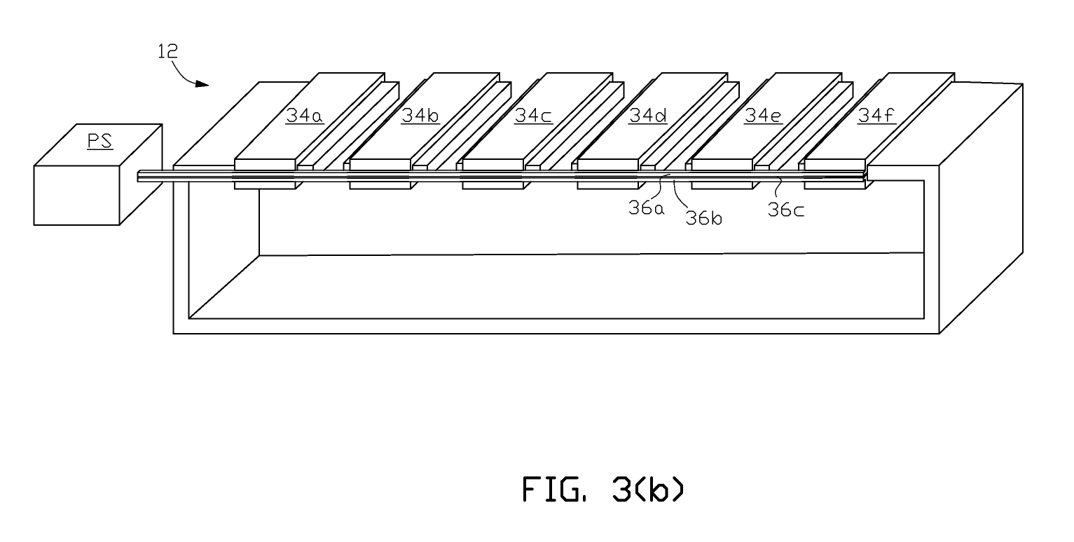

FIG. 3(a) and FIG. 3(b) illustrate apparatus 10b of the present invention, which is similar to the apparatus shown in FIG. 1 except that the inductors are formed from single-turn sheet inductors 34a through 34f. Each single-turn sheet inductor may be formed, for example, from a copper sheet and be wound around each section of ferromagnetic material facing a longitudinally-oriented gap. Although not so illustrated in the drawings, preferably, each sheet inductor extends to near the edge at each gap (for example, edges 12b′ and 12c′ in FIG. 3(a)) so that each sheet inductor is positioned around the ferromagnetic material adjacent to a side of the through-gaps. As illustrated in FIG. 3(b), in this example of the invention, each single-turn sheet inductor is suitably connected to power supply bus bars 36a and 36b (separated by dielectric 36c) that supply alternating current to the solenoidal coils (connected in parallel in this example) from power source (PS).

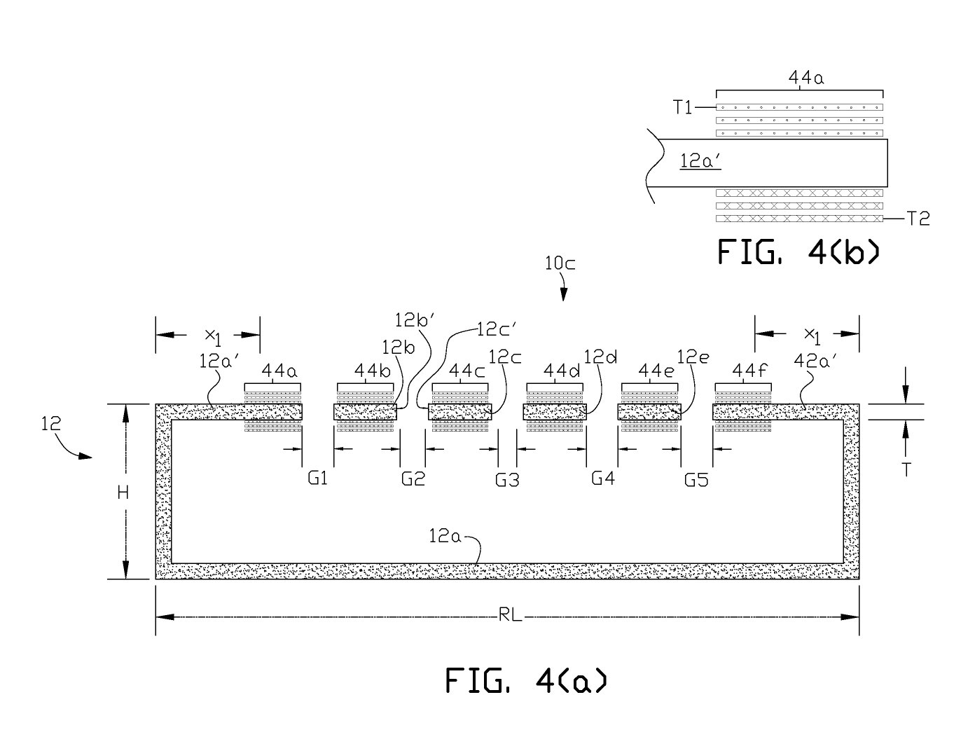

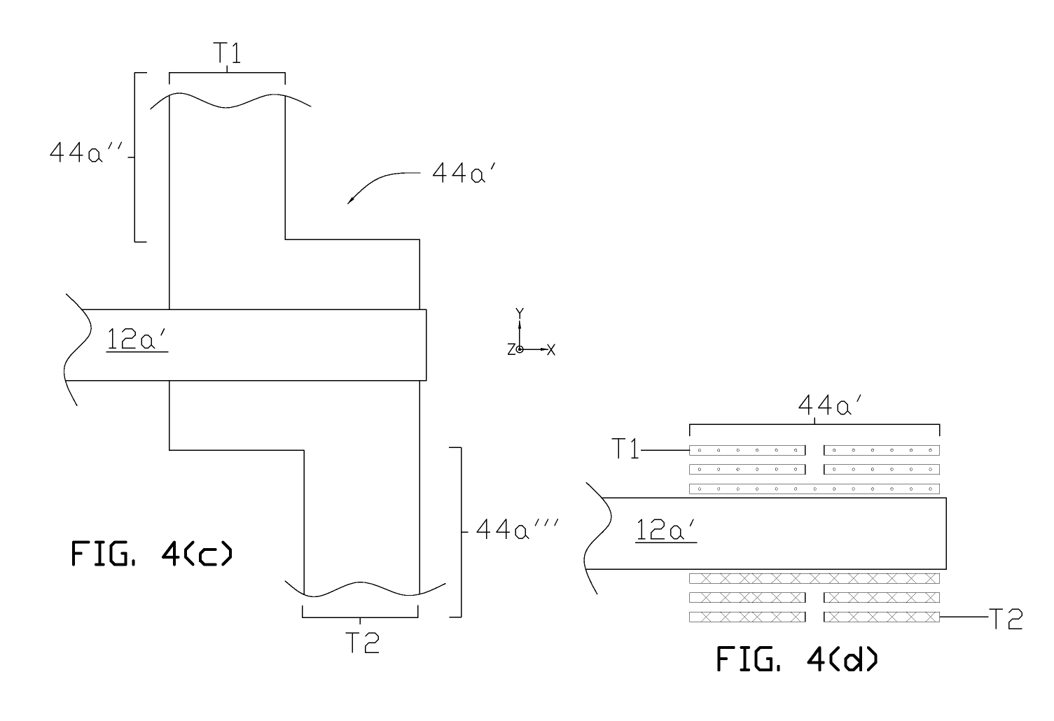

FIG. 4(a) illustrates apparatus 10c of the present invention, which is similar to the apparatus shown in FIG. 1 except that the inductors are formed from multi-layer wound ribbon inductors 44a through 44f wherein the ribbon comprises an electrical conductor/insulator two-layer composite material or separate back to back electrical conductor and insulator layers that can be wound in an overlapping multi-layer arrangement such that substantially all of the magnetic flux is contained to the ferrite. Each multi-layer ribbon inductor is wound around each section of ferromagnetic material facing a gap and suitably connected to an alternating current power source, for examples at terminals T1 and T2 as illustrated in FIG. 4(b) for multi-layer wound ribbon inductor 44a. FIG. 4(c) illustrates a method of wrapping a multi-layer wound ribbon inductor 44a′ (shown flat in FIG. 4(c)) around ferromagnetic section 12a′ and adjacent to a side of a through-gap where half-section 44a″ is wrapped counterclockwise (about X-axis in Y-Z direction) around ferromagnetic section 12a′ and half-section 44a′″ is wrapped clockwise (about X-axis in Y-Z direction) around ferromagnetic section 12a′ to achieve the wound configuration shown in FIG. 4(d). Preferably each wound ribbon inductor extends to the edge at each gap (for example, edges 12b′ and 12c′ in FIG. 4(a)).

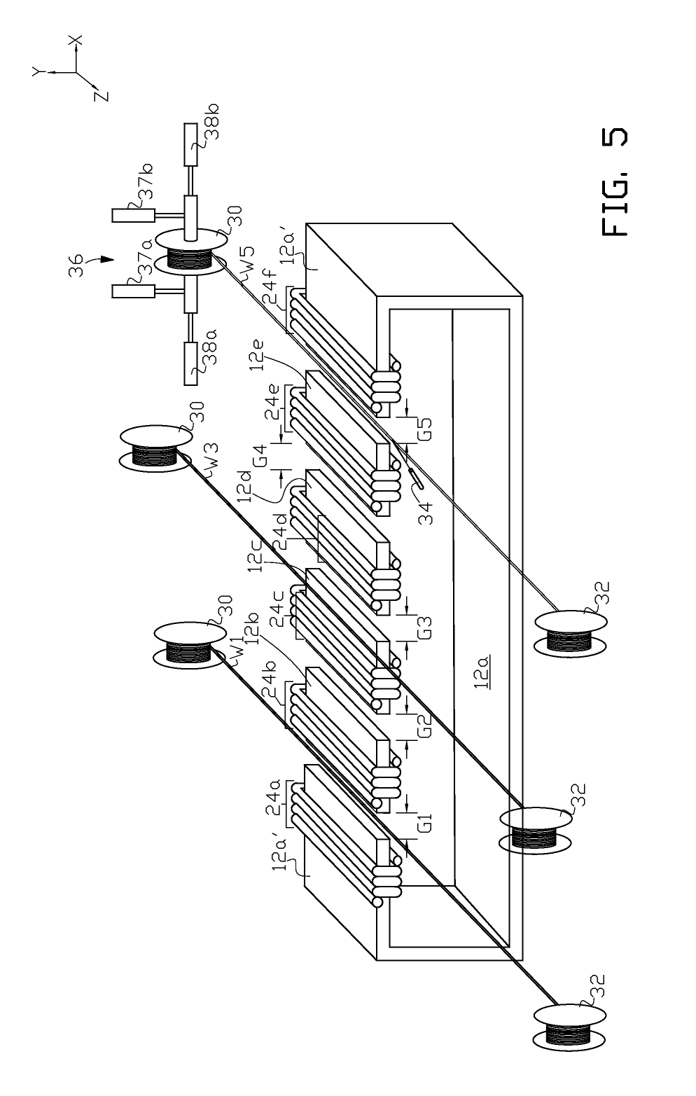

FIG. 5 illustrates one example of the invention shown in FIG. 2(a) through FIG. 2(d) where a maximum of five separate longitudinally-oriented continuous workpieces (wires in this example) can be heat treated simultaneously with one wire in each of the five gaps G1 through G5. Each wire can be fed through the length of a gap from a separate supply reel 30 to take-up reel 32. Prior to gap feed through, the wire may be subjected to another industrial process, such as dipping in a coating material.

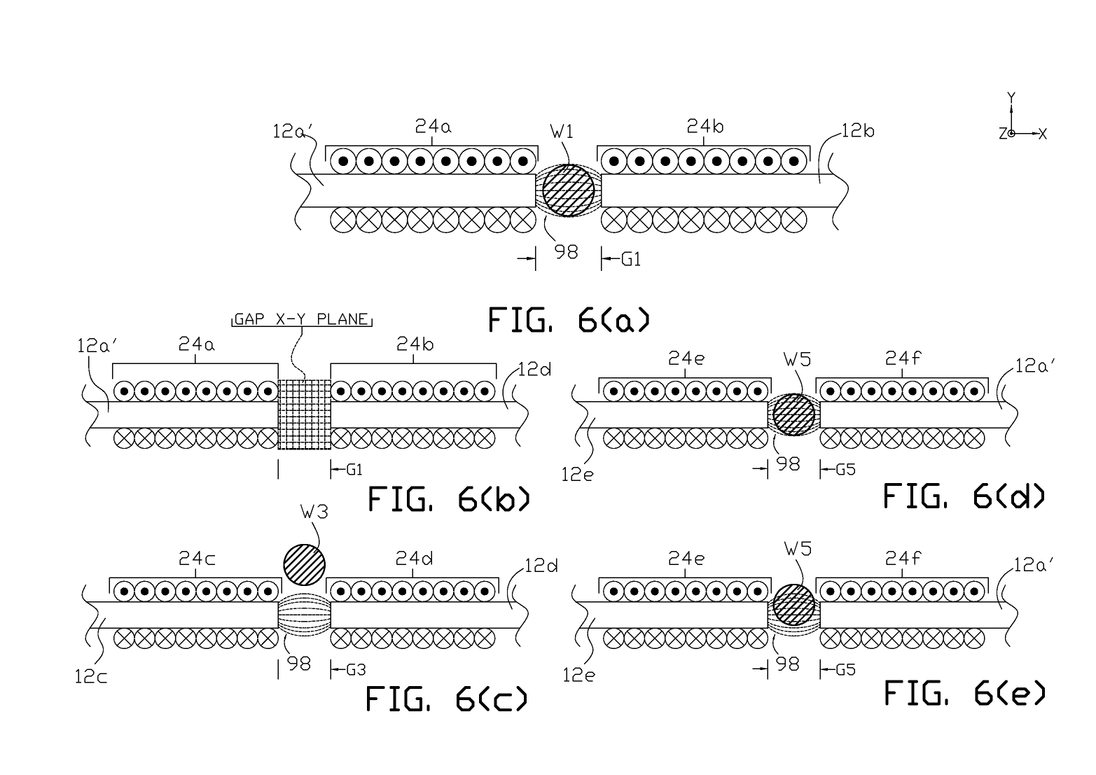

Each wire can be provided with a separate feeder and gap positioning apparatus. For example, feeder and gap positioning apparatus 36 shown in FIG. 5 for gap G5 is used to insert and remove a wire from gap G5, and/or alter the position of a wire as it moves through the gap relative to a suitable gap X-Y reference plane that can be established. Actuators 37a and 37b can be used to adjust the wire in the Y-direction within the gap and actuators 38a and 38b can be used to adjust the wire in the X-direction within the gap. For example, the feeder gap positioning apparatus for wire W3 in FIG. 5, which is heat treated in gap G3, has removed wire W3 from the gap X-Y reference plane (illustrated in FIG. 6(b)) as shown removed in FIG. 5 and FIG. 6(c). Similar feeder and gap positioning apparatus may be provided with take-up reel 32 for gap-G5.

The gap positioning apparatus can be used to change the location of a wire in the gap X-Y reference plane within a gap so that the intensity of the transverse magnetic flux 98 coupling with the wire, and therefore inductively heating the wire changes, as illustrated in FIG. 6(d) and FIG. 6(e). Changing the location of a wire in the gap X-Y reference plane can also be used to regulate the induced power delivered to the wire.

In some examples of the invention, one or more thermal sensors 34, as diagrammatically shown in FIG. 5, can be used to measure the temperature of the heated wire (W5 in this example) as it exits heating gap G5. The measured temperature data can be stored and analyzed by a computer processor executing a heat control program that can output control signals for adjustment of the output power from the power supply PS supplying power to the induction coils and/or adjusting the location of wire W5 in the gap X-Y Plane responsive to the measured temperature data to achieve a required heating profile for the wire.

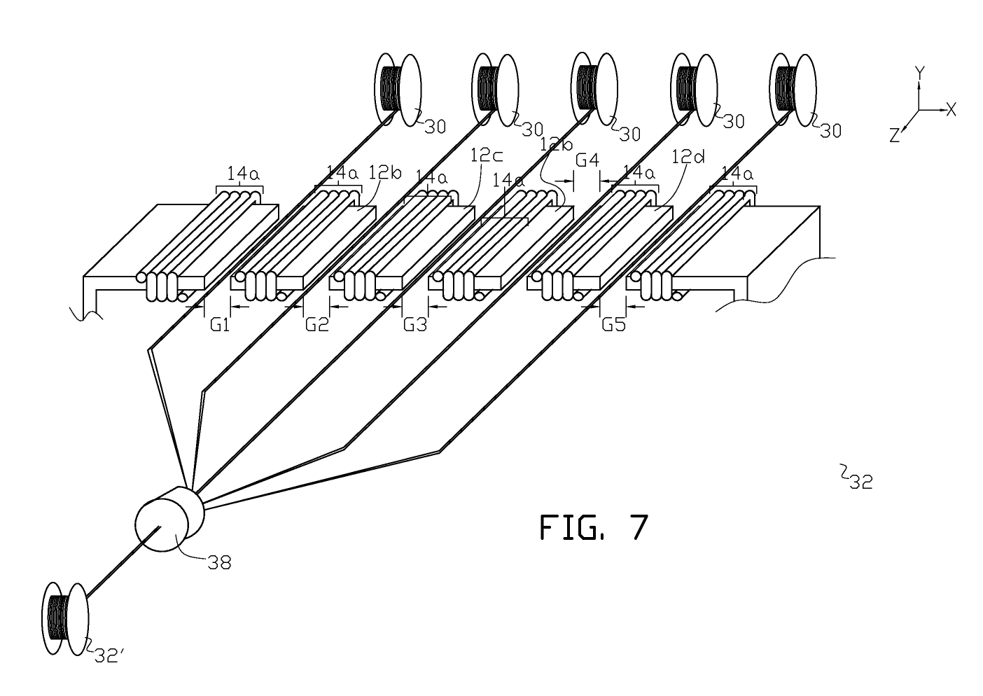

FIG. 7 illustrates another example of the present invention wherein each of five strands (wires) of a stranded cable is individually heat treated and then wound together by winding apparatus 38 to form a five strand cable.

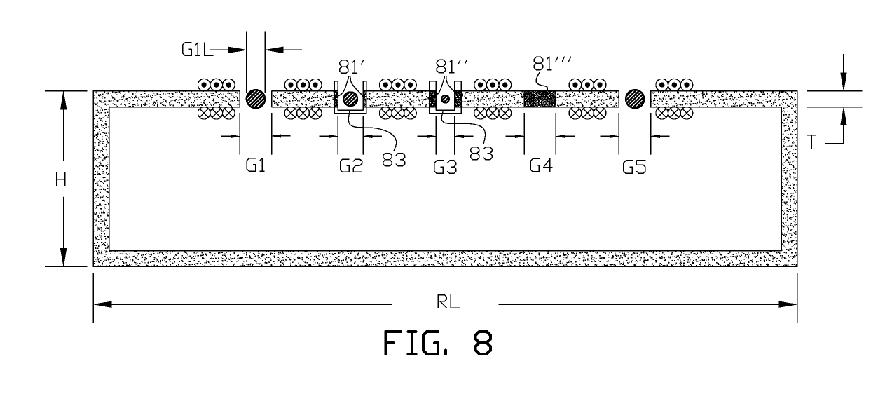

FIG. 8 illustrates the optional use of extender ferrites (shown dark stippled) that can be inserted into a wire gap to adapt the air gap dimension to adjust the flux density to a particular wire shape (including diameter, if circular in cross section) in order to control the induced heating as shown by extender ferrites 81′ and 81″ for gaps G2 and G3 by bridging and concentrating the magnetic flux within the gaps. The ferrite may be formed, for example, in a “U” shaped non-ferromagnetic carrier 83 in which the extender ferrite 81′ and 81″ may be embedded as shown in FIG. 8. An extender ferrite may also be used to close a gap in which a wire is not currently passing through, for example, as extender ferrite 81′″ shown for gap G4 in FIG. 8.

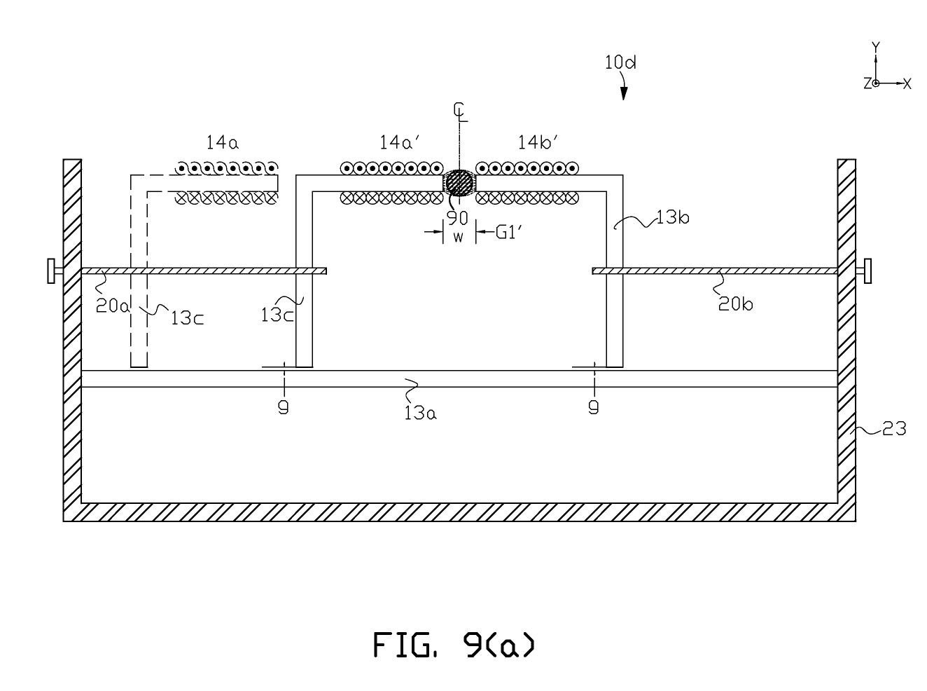

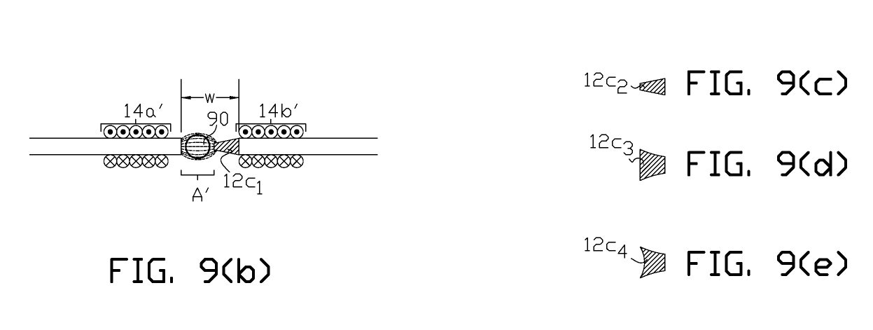

FIG. 9(a) illustrates another example of the present invention where apparatus 10d accommodates induction heat treatment of a single longitudinally-oriented continues workpiece 90. The open-box rectangular ferromagnetic material comprises ferromagnetic sections 13a, 13b and 13c. Fixed ferromagnetic section 13a may be mounted to suitable structural element 23. Inductors 14a′ and 14b′ surround the ferromagnetic material on opposing sides of through-gap G1′ and adjacent to each side of the gap. Optionally suitable position actuators 20a and 20b can be provided to control X-direction positioning of either one or both of the opposing “L” shaped ferromagnetic sections 13b and 13c based upon the dimensions of a particular workpiece and the desired transverse flux pattern across the wire in the gap so that the apparatus 10d has an adjustable-width longitudinally-oriented workpiece through-gap. For example actuators 20a and 20b may be threaded devices that when rotated (about the X-axis) interact with a threaded connection in ferromagnetic sections, 13c and 13b, respectively to move ferromagnetic sections 13c and 13b in the X-direction. A sample alternative position for ferromagnetic section 13c is shown in dashed lines in FIG. 9(a). Suitable apparatus can also be provided to control X-direction positioning of ferromagnetic segments between one (or more) of the transverse flux induction heating gaps used in the multi-gap examples of the invention described above. Optionally a suitable (Y-direction) position actuator can be provided to control the width of gaps, g, between fixed ferromagnetic section 13a and moveable ferromagnetic sections 13b and 13c to control the reluctance in the magnetic circuit in FIG. 9(a).

As an alternative to movement of ferromagnetic sections to adjust the width, w, of a gap, or in combination therewith, in some examples of the invention flux path adaptors, or control tips, can be utilized. In some applications the adaptor may be used only to reduce the width of a gap, w. In these applications the adaptor (12c₁) as shown in FIG. 9(b) would be shaped identical to the end of the ferromagnetic section it is attached to. In other applications, as shown in FIG. 9(c) through 9(e) the magnetic flux control tip (12c₂-12c₄) is contoured to alter the transverse flux pattern in the gap. A suitable non-electromagnetic mounting apparatus formed for example, from a ceramic composition, can be provided to allow quick replacement or removal of an adaptor without modification to heating apparatus of the present invention.

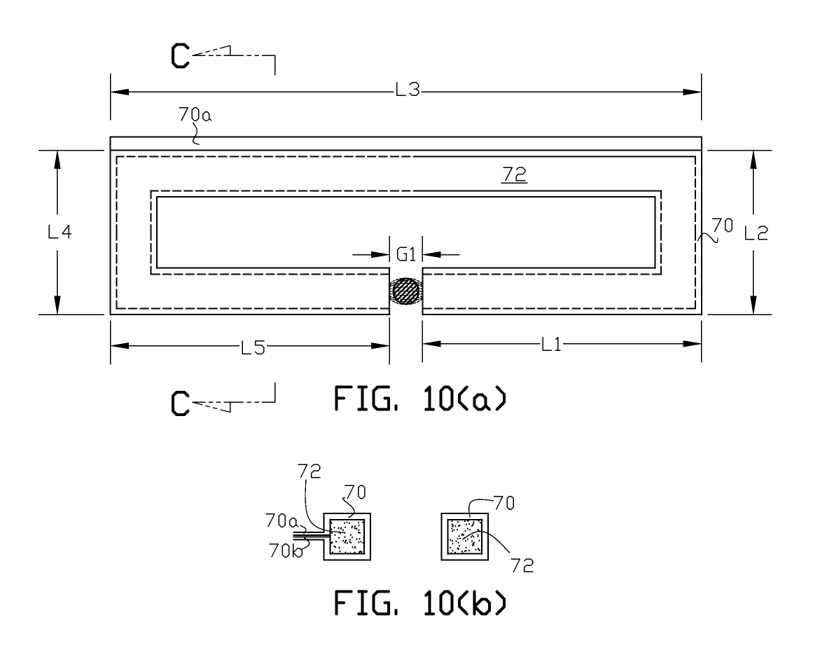

FIG. 10(a) and FIG. 10(b) illustrate another example of the electric induction heat treatment apparatus of the present invention where a single-turn sheet inductor 70 (for example, formed a copper sheet) surrounds the entire length (L1+L2+L3+L4+L5) (except for the facing gap sides (tips)) a C-shaped ferromagnetic open-box rectangular material 72 having a longitudinally-oriented workpiece through-gap G′ in which a longitudinally-oriented workpiece moves through. Alternating current power is suitably supplied to the sheet inductor, for example at side terminals 70a and 70b. In some example of the invention, the entire length of open-box rectangular ferromagnetic material for apparatus 10d in FIG. 9(a) can be surrounded by a single inductor of any type described above. Similarly the entire length of the open-box rectangular ferromagnetic material for apparatus 10 in FIG. 1 can be surrounded by an inductor of any type; that is, end inductors 14a and 14f can be extended as a single inductor entirely around sides H and RL.

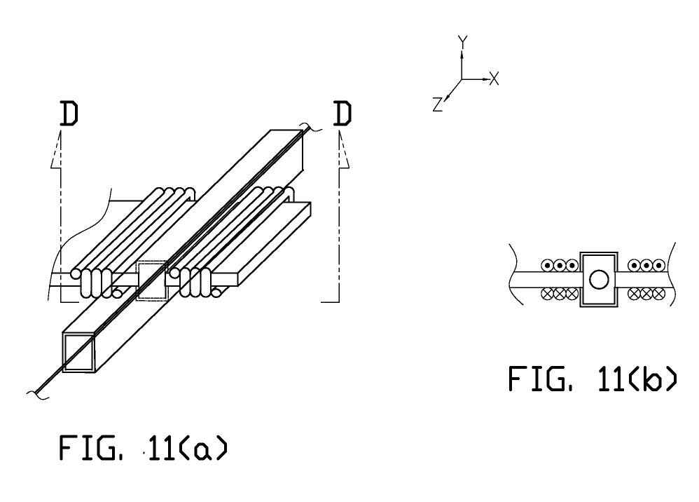

In some applications the induction heating of the workpiece in the gap requires a sealed environment, in which case a sealed tunnel may be provided in the longitudinal gap of the apparatus as illustrated in FIG. 11(a) and FIG. 11(b). The material can be formed from a non-ferrous and non-electrically conductive material such as a ceramic.

The present invention is particularly useful in wire galvanizing or zinc coating applications since the induction heating is very efficient and provides for precise control of wire temperature in each gap, which is not possible in existing applications. Consequently energy demands for heating the galvanizing tank which contains the molten zinc or other alloy are greatly reduced. This allows increased tonnage throughput without modifying the heating system which heats the molten zinc.

In some examples of the invention, the wire may be rotated around its central axis as it passes through the length, L, of the gap to assist in uniform cross sectional heating of the wire.

While the longitudinally-oriented continuous workpiece described in the above examples of the invention is generally described as a wire having a circular cross section, other types of longitudinally-oriented continuous workpieces, such as but not limited to rods, conduit and cables formed from a plurality of wires, and such continuous workpieces with circular or other cross sectional shapes, can also be induction heat treated by the apparatus and method of the present invention. The term “heat treatment” is used herein to describe an industrial process wherein induction heat application to the workpiece can be utilized either as an alternative to an existing induction heat treatment process or replacement of a non-induction heat treatment process, for example in a wire galvanizing or zinc coating processes, lead heating systems for metallurgical transformation in multi-wire applications, and non-ferrous workpiece heating such as, but not limited to aluminum, copper and titanium. Further the workpiece may be a composite wherein only a partial constituent of the workpiece composition is electrically conductive for induced eddy current heating. The term “wire” is used in the broadest sense and includes single strand, and multi-stranded, cylindrical, or otherwise shaped in cross section. The term “continuous” is used herein as meaning at least sufficiently long so that the workpiece can be transported through the gap without the workpiece transport apparatus traveling through the gap.

The present invention has been described in terms of preferred examples and embodiments. Equivalents, alternatives and modifications, aside from those expressly stated, are possible and within the scope of the invention.

1. An electric induction heat treatment apparatus for heat treatment of a plurality of longitudinally-oriented continuous workpieces, the electric induction heat treatment apparatus comprising:
a series magnetic loop circuit formed from an open-box rectangular ferromagnetic material having a plurality of longitudinally-oriented workpiece through-gaps for insertion of one of the plurality of longitudinally-oriented continuous workpieces in each one of the plurality of longitudinally-oriented workpiece through-gaps as each one of the plurality of longitudinally-oriented continuous workpieces moves through the plurality of longitudinally-oriented workpiece through-gaps, each of the plurality of longitudinally-oriented workpiece through-gaps having a gap width to establish a transverse magnetic flux within the gap perpendicularly oriented to the one of the plurality of longitudinally-oriented continuous workpieces moving through the one of the plurality of longitudinally-oriented workpiece through-gaps;
a plurality of inductors, each one of the plurality of inductors positioned around the open-box rectangular ferromagnetic material adjacent to a side of each one of the plurality of longitudinally-oriented workpiece through-gaps; and
at least one alternating current power supply connected to the plurality of inductors.

2. The electric induction heat treatment apparatus of claim 1 wherein the plurality of inductors comprise a plurality of multi-turn solenoidal induction coils or a plurality of single-turn sheet inductors.

3. The electric induction heat treatment apparatus of claim 1 wherein the plurality of inductors comprise a plurality of multi-layer wound ribbon inductors.

4. The electric induction heat treatment apparatus of claim 1 wherein the plurality of inductors surround the entire length of the open-box rectangular ferromagnetic.

5. The electric induction heat treatment apparatus of claim 1 further comprising a workpiece feeder and positioning system for at least one of the plurality of longitudinally-oriented continuous workpieces.

6. The electric induction heat treat apparatus of claim 1 further comprising a winding apparatus to wind together all of the plurality of longitudinally-oriented continuous workpieces subsequent to moving the plurality of longitudinally-oriented continuous workpieces through the plurality of longitudinally-oriented workpiece through-gaps.

7. The electric induction heat treat apparatus of claim 1 further comprising an extender ferrite inserted in at least one of the plurality of longitudinally-oriented workpiece through-gaps.

8. The electric induction heat treat apparatus of claim 1 further comprising a flux path adapter inserted in at least one of the plurality of longitudinally-oriented workpiece through-gaps.

9. The electric induction heat treat apparatus of claim 1 wherein the plurality of inductors is extended to entirely surround the open-box rectangular ferromagnetic material.

10. The electric induction heat treat apparatus of claim 1 further comprising a controlled atmosphere electromagnetically transparent tunnel around at least a sealed one of the plurality of longitudinally-oriented workpiece through-gaps within which the longitudinally-oriented continuous workpiece in the sealed one of the plurality of longitudinally-oriented workpiece through-gaps moves through.

11. A method of inductively heat treating a plurality of longitudinally-oriented continuous workpieces, the method comprising the steps of:
supplying alternating current power to a series magnetic loop circuit formed from an open-box rectangular ferromagnetic material having a plurality of longitudinally-oriented workpiece through-gaps;
establishing a transverse magnetic flux across the width of each one of the plurality of longitudinally-oriented workpiece through-gaps; and
moving each one of the plurality of longitudinally-oriented continuous workpieces perpendicularly to the transverse magnetic flux through each one of the plurality of longitudinally-oriented workpiece through-gaps.

12. An electric induction heat treatment apparatus for heat treatment of a longitudinally-oriented continuous workpiece, the electric induction heat treatment apparatus comprising:
a series magnetic loop circuit formed from an open-box rectangular ferromagnetic material having an adjustable-width longitudinally-oriented workpiece through-gap for insertion of the longitudinally-oriented continuous workpiece as the longitudinally-oriented continuous workpiece moves through the adjustable-width longitudinally-oriented workpiece through-gap, the adjustable-width longitudinally-oriented workpiece through-gap having a gap width to establish a transverse magnetic flux within the adjustable width longitudinally-oriented workpiece through-gap perpendicularly oriented to the length of the longitudinally-oriented continuous workpiece moving through the adjustable-width longitudinally-oriented workpiece through-gap;
a pair of inductors, each one of the pair of inductors positioned around the open-box rectangular ferromagnetic material adjacent to an opposing side of the adjustable-width longitudinally-oriented workpiece through-gap; and
at least one alternating current power supply connected to the pair of inductors.

13. The electric induction heat treatment apparatus of claim 12 wherein at least one section of the open-box ferromagnetic material adjacent to the longitudinally-oriented continuous workpiece through-gap is adjustable in position relative to the longitudinally-oriented continuous workpiece through-gap to adjust the width of the gap.

14. The electric induction heat treatment apparatus of claim 12 wherein the pair of inductors comprise a pair of multi-turn solenoidal induction coils or a pair of single-turn sheet inductors.

15. The electric induction heat treatment apparatus of claim 12 wherein the pair of inductors comprise a pair of multi-layer wound ribbon inductors.

16. The electric induction heat treatment apparatus of claim 12 further comprising a workpiece feeder and positioning system for the longitudinally-oriented continuous workpiece.

17. The electric induction heat treat apparatus of claim 12 further comprising an extender ferrite inserted in the adjustable-width longitudinally-oriented workpiece through-gap.

18. The electric induction heat treat apparatus of claim 1 further comprising a flux path adapter inserted in the adjustable-width longitudinally-oriented workpiece through-gap.

19. The electric induction heat treat apparatus of claim 12 wherein the pair of inductors surround the entire length of the open-box rectangular ferromagnetic material.

20. The electric induction heat treat apparatus of claim 12 further comprising a controlled atmosphere electromagnetically transparent tunnel around the adjustable-width longitudinally-oriented workpiece through-gap within which the longitudinally-oriented continuous workpiece moves through.

21. A method of inductively heat treating a longitudinally-oriented continuous workpiece, the method comprising the steps of:
supplying alternating current power to a series magnetic loop circuit formed from an open-box rectangular ferromagnetic material having an adjustable-width longitudinally-oriented workpiece through-gap;
establishing a transverse magnetic flux across the width of the adjustable-width longitudinally-oriented workpiece through-gap; and
moving the longitudinally-oriented continuous workpiece perpendicularly to the transverse magnetic flux through the adjustable-width longitudinally-oriented workpiece through-gap.
